(19) United States
(12) Patent Application Publication
(10) Pub. No.: US 2009/0133872 A1
(43) Pub. Date: May 28, 2009

(54) Flow back separators

(76) Inventors: Donald W. Shackelford, Houston, TX (US); Michael L. Clark, Houston, TX (US); Robert T. Hendrix, Pinehurst, TX (US); Glendell S. Hendrix, Magnolia, TX (US)

Correspondence Address: THOMPSON & KNIGHT, L.L.P.;PATENT PROPERTY DEPARTMENT, 1722 ROUTH STREET, SUITE 1500, DALLAS, TX, 75201-2533, US

(21) Appl. No.: 12/290,608

(22) Filed: Oct. 31, 2008

Related U.S. Application Data
(60) Provisional application No. 61/001,645, filed on Nov. 2, 2007.

(51) Int. Cl. E21B 43/00; E21B 21/06; B01D 33/27; C02F 1/38

(52) U.S. Cl. 166/267; 166/75.12; 210/512.1; 210/788

(57) ABSTRACT

A flow back separator including a housing including a bore housing for communicating with a solid collection chamber, an inlet port for receiving formation fluid flow, and a helical member disposed within the housing bore for directing formation fluid flow received through the inlet port along a helical path wherein solids within the formation fluid flow are forced towards a wall of the housing bore under centrifugal force.

### CROSS-REFERENCE TO RELATED DATA

The present application claims the benefit of U.S. Provisional Patent Application Ser. No. 61/001,645, filed Nov. 2, 2007.

### FIELD OF INVENTION

The present invention relates in general to hydrocarbon extraction equipment and in particular to flow back separators for removing solids from formation fluids.

### BACKGROUND OF INVENTION

Formation fluids being pumped from an oil or gas formation typically include unwanted solids, which can damage components in the downstream piping and processing equipment. Hence it is important to remove these solids relatively soon after the formation fluids reach the surface. Normally solids are separated from formation fluids using flow back separators.

All current flow back separator designs receive a flow of formation fluids, which continues into an underlying collection chamber where a percentage of the solids settle to the chamber bottom under the force of gravity. The formation fluids are then forced upward from the collection chamber and exit horizontally from the flow separator with a reduced percentage of solids. Because conventional separators essentially operate only using the force of gravity, the energy available to separate the solids from the fluids is limited, which in turn limits the effectiveness of the separation process. Moreover, the downward fluid flow tends to stir the solids in the collection chamber, which also limits the percentage of the solids removed by the separator.

### SUMMARY OF INVENTION

The principles of the present invention are embodied in helical flow back separators suitable for use in hydrocarbon extraction systems. According to one particular embodiment, a flow back separator is disclosed that includes a housing defining a bore housing therethrough for communicating with a solid collection chamber, an inlet port for receiving formation fluid flow, and a helical member disposed within the housing bore for directing formation fluid flow received through the inlet port along a helical path such that solids within the formation fluid flow are forced towards a wall of the housing bore under centrifugal force.

Among other things, helical separators according to the present inventive principles, which apply centrifugal force to the formation fluid flow, advantageously provide more energy for separating formation fluids and solids compared to conventional gravity-only separators. In addition, by bringing the fluid flow into the separator through a horizontal inlet, the downward fluid velocity is reduced, which advantageously reduces the amount of stirring in the collection chamber and consequently the percentage of solids that exit the collection chamber through the separator and on to downstream processing equipment.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is a high level diagram of a typical system for extracting hydrocarbons from an underground formation and suitable for demonstrating a typical application of a helical flow separator embodying the principles of the present invention;

FIG. 2A is a diagram providing a perspective view of an exemplary helical flow back separator embodying the principles of the present invention and suitable for use in the system shown in FIG. 1;

FIG. 2B is a side view of the helical flow back separator of FIG. 2A;

FIG. 2C is a cut-away diagram of the helical flow back separator of FIG. 2A;

FIG. 2D is a diagram of the flange tube of the helical flow back separator of FIG. 2A;

FIGS. 2E and 2F are diagrams of the inlet flange block and horizontal formation fluid inlet of the helical flow back separator of FIG. 2A;

FIG. 2G is a diagram of the upper flange block shown in FIG. 2A;

FIG. 2H is a diagram of the wear sleeve shown in the cut-away view of FIG. 2C;

FIG. 2I is a diagram of the helical insert shown in the cut-away view of FIG. 2C; and

FIG. 2J is a diagram showing the adjustable nozzle shown in the cut-away view of FIG. 2C.

### DETAILED DESCRIPTION OF THE INVENTION

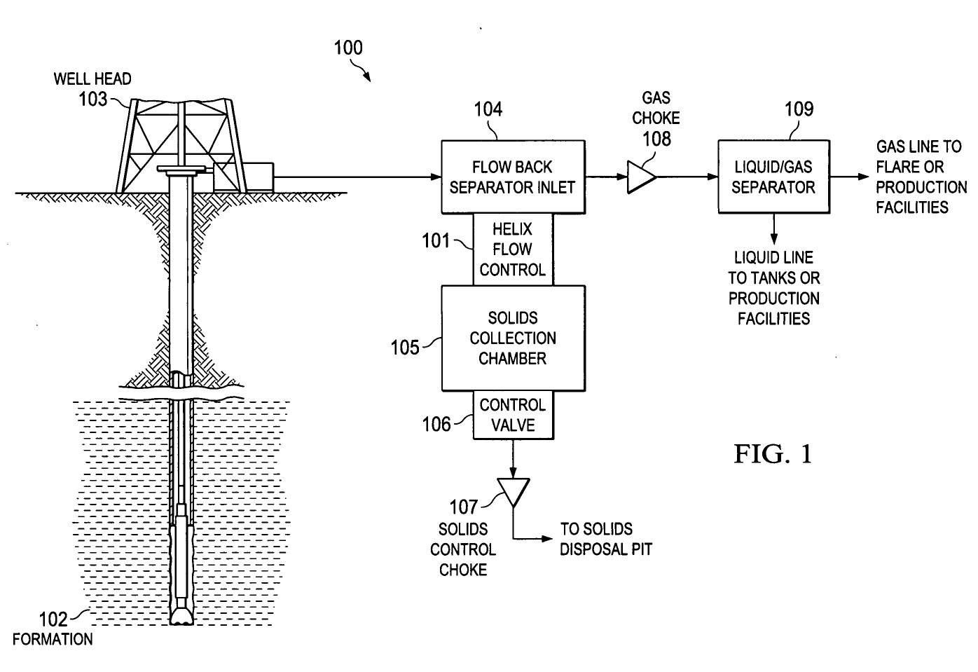

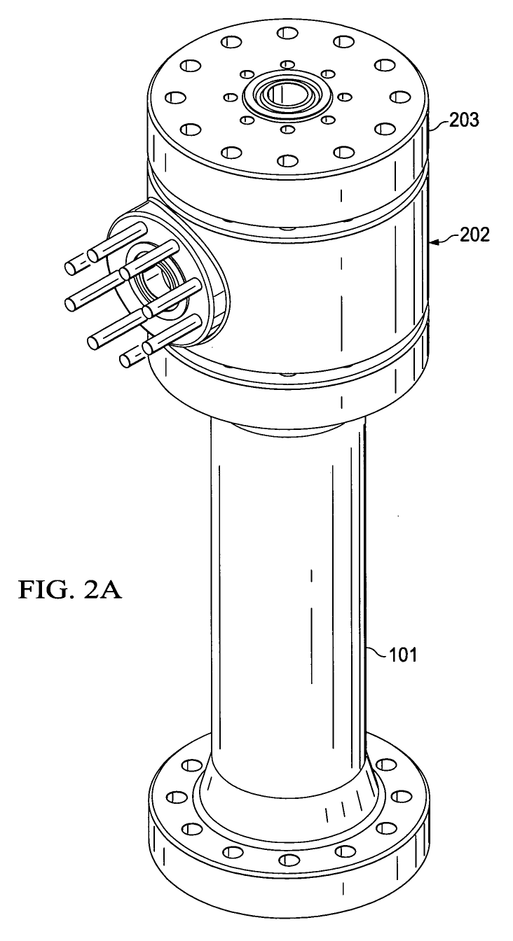

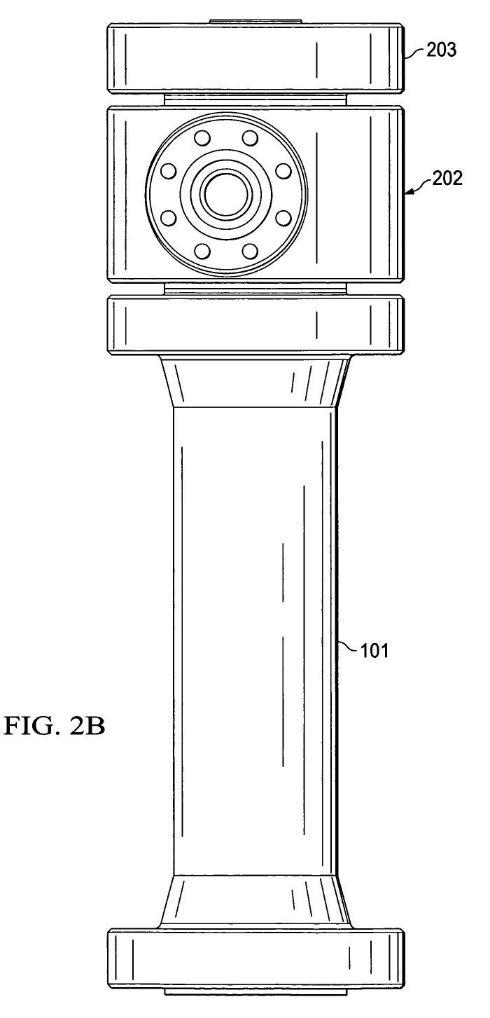

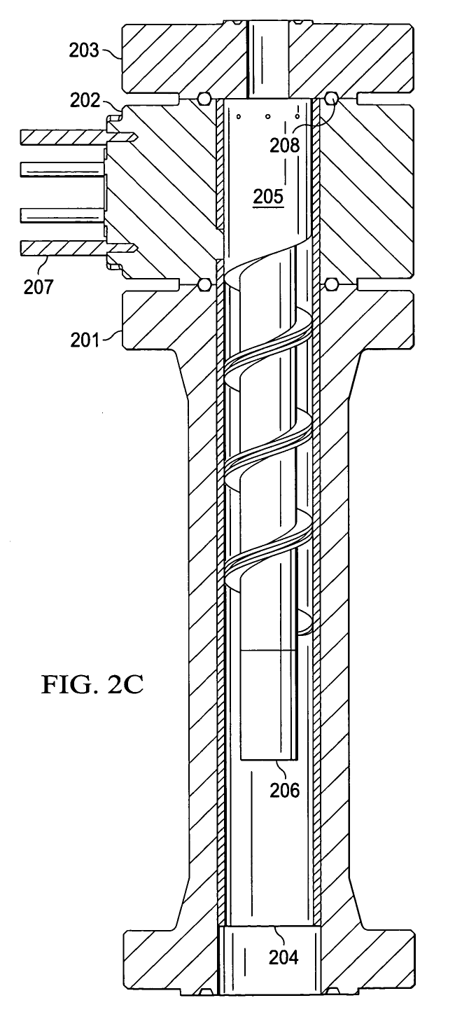

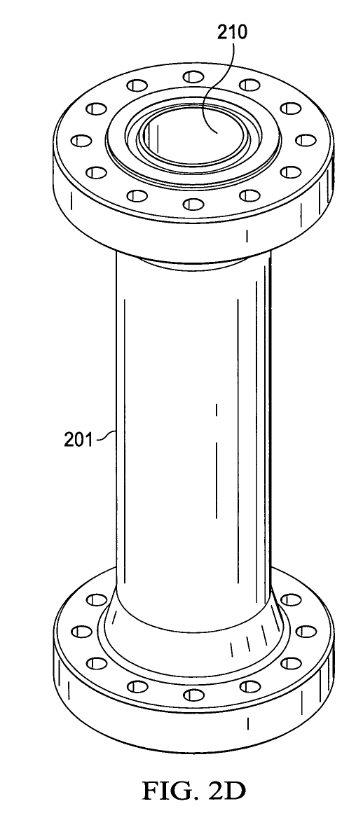

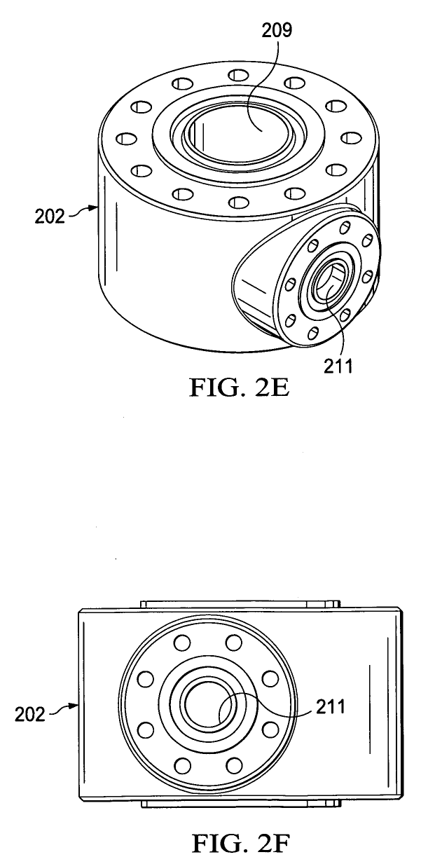

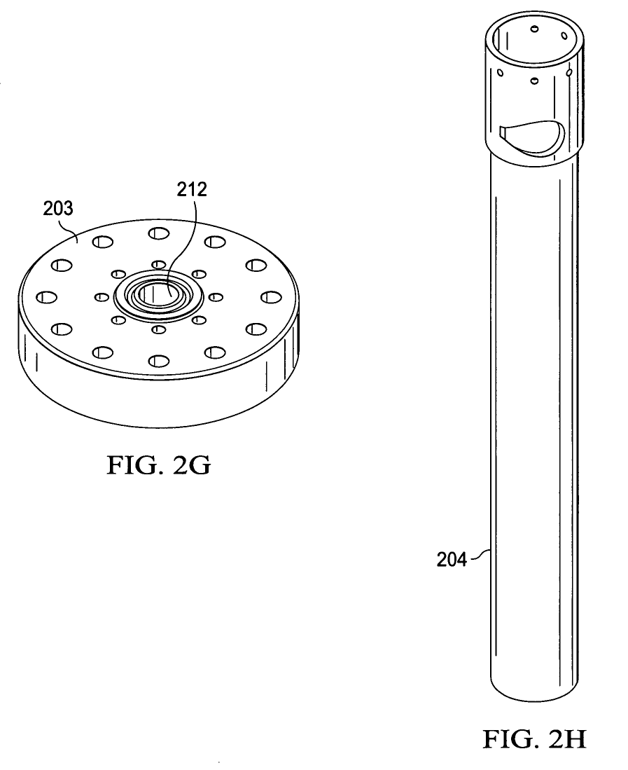

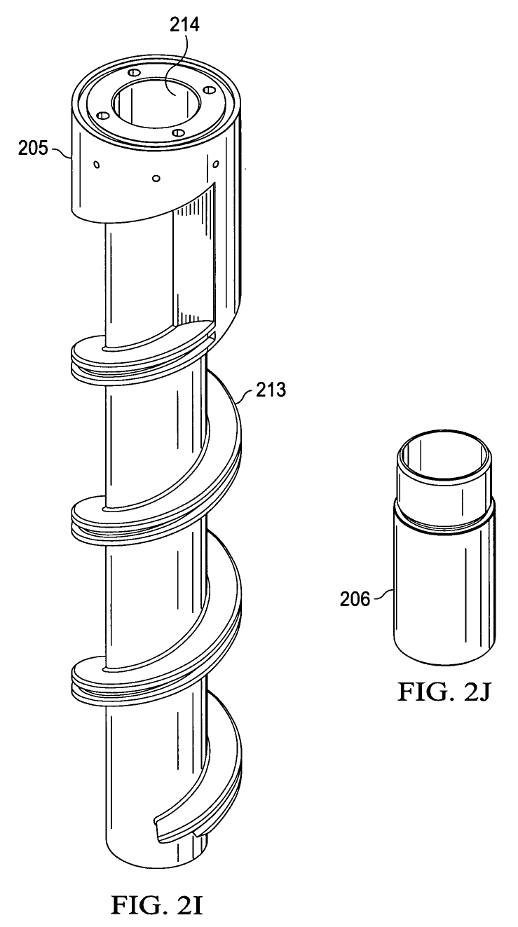

The principles of the present invention and their advantages are best understood by referring to the illustrated embodiment depicted in FIGS. 1-2 of the drawings, in which like numbers designate like parts.

FIG. 1 is a high level diagram of a representative hydrocarbon extraction system 100 suitable for describing a typical application of the principles of the present invention, as embodied in helical flow back separator 101.

In system 100, formation fluids extracted from an underground formation 102 pass through the well head 103 and on to the flow back separator inlet 104. As discussed in detail below, according to the present inventive principles, helical flow back separator 101 receives the formation fluid flow through a horizontal (side) port and directs that flow along a downward helical path, which applies centrifugal force to the formation fluid flow. This centrifugal force separates the solids out of the formation fluids and forces the solids to the outer housing wall of flow back separator 101. Once the flow reaches the lower part of the helical path, the formation fluids are directed to the center of solids collection chamber 105, while the solids tend towards collection chamber walls, where they fall free to the chamber bottom.

The formation fluids, less a substantial amount of the solids, travel upwards from solids collection chamber 105, under reduced pressure, through a straight path through the center of flow back separator 101, and on to gas choke 108. The separated solids, which have settled to the bottom of solids collection chamber 105, are blown out of the collection chamber using throttling device and valve 106 and solids control choke 107. Separated foundation fluids flowing upward through the center of helical flow back separator 101 are passed through gas choke 108 and liquid/gas separator 109 and on to production facilities/storage or a gas flare.

Helical flow back separator 101 is suitable for removing formation solids under a number of different circumstances. Generally, the formation fluids are either oil or gas, which are sometimes extracted along with water or salt water, depending on the particular formation. In some situations, fracturing fluids, which have been pumped into the formation under pressure, may also be recovered when those fluids flow back to the surface. In each case, the formation fluids forced from formation to the surface contain solids, such as formation materials of various sizes and proppants. (Generally, proppants are composed of spherical particles, which hold formation fractures open after fracturing of the formation by hydraulic pressure and fracturing fluids, to provide a high conductivity path allowing formation fluids to more efficiently flow into the well bore).

If a sufficient percentage of the solids are not removed from the formation fluid flow, downstream components in the process piping, such as valves, chokes, tees, ells, and even straight piping, can be damaged due to erosion. This problem is compounded for gas wells, where a substantial pressure drop from the well head pressure to the downstream piping pressure can impart a high energy to the solid material thereby increasing the erosion. Moreover, if a sufficient percentage of the solids are not removed from the fluid flow, chokes and other small diameter passages in the piping can plug-up, requiring time consuming cleaning. If this cleaning involves any disassembly of the piping, that piping must be pressure tested following reassembly to insure that the system is still mechanically competent to handle the required pressure. (Pressure testing can not only be time consuming, but also requires the availability of the requisite test equipment.)

FIG. 2A is a more detailed diagram of helical flow back separator 101. Cut-away views are provided in FIGS. 2B and 2C. Generally, helical flow back separator 101 and its constituent components are fabricated from steel or a similar metal, although the principles of the present invention are not limited to those specific materials. For clarity, the fastening bolts have not been shown in the drawings.

As shown in the cut-away view of FIGS. 2C, helical flow back separator 101 includes a flange tube 201, which is shown in further detail in FIG. 2D. An inlet flange block 202, which is shown in further detail in FIGS. 2E and 2F, is bolted to the upper flange of flange tube 201. As discussed further below, and shown in FIGS. 2B, 2E, and 2F, flange block 202 includes an inlet port 211 having an axis which is laterally offset from the axis of bore 210 of flange tube 201 and bore 209 of the flange block 202. An upper flange block 203, such as shown in FIG. 2G, and having a bore 212 defined therethrough, is bolted to the upper surface of flange block 203.

A removable wear sleeve 204, which is shown in further detail in FIG. 2H, extends substantially through bore 209 of flange block 202 and along the length of bore 210 of flange tube 201. Helical insert 205, as shown in FIG. 2I, extends through bore 209 of flange block 202 and partially through bore 210 of flange tube 201 within wear sleeve 204. Helical insert 205 includes a continuous helical projection 213 running along its outer surface. In the illustrated embodiment of helical insert 205, helical projection 213 includes three (3) full turns, although in alternate embodiments, the number of turns in the helix may vary. For example, in some embodiments, helical insert 213 may be fabricated to include only two (2) full turns and in other embodiments, may be fabricated to include four (4) or more full turns around the outer surface of helical insert 205. Helical insert 205 also includes a bore 214 along its longitudinal axis. As discussed further below, bore 214 conducts formation fluids exiting from helical flow back separator 101 and the underlying solid collection chamber.

A variable length nozzle 206, which is shown in further detail in FIG. 2J, is fastened to the lower end of helical insert 205. A set of studs 207 on a flange block 202 allow a flange block 202 to mate with an inlet pipe bringing formation fluids to helical flow back separator 101. O-rings 208 disposed between flange block 202 and upper flange tube 201 and flange block 203 prevent a leakage of formation fluids during operation.

During operation, formation fluids, including any solids, enter helical flow back separator 101 horizontally through offset inlet port 211 in flange block 202. Advantageously, offset inlet port 211 initiates the helical flow of the incoming fluids. These fluids are then directed downward by helical projection 213 on helical insert 205. The resulting centrifugal force forces the solids within the formation fluid flow outward towards wear sleeve 204. At the bottom of helical insert 205, variable length nozzle 206 directs the fluid flow towards the center of bore 209 of flange tube 201 while the solids tend towards the outer wall of bore 210 flange tube 201 and wear sleeve 204. The fluid flow then continues towards the center of underlying solid collection chamber 105 while the separated solids settle to the chamber bottom.

The exiting formation fluids return upward through bore 210 of flange tube 201, through the center bore 214 of helical insert 205, and out through a bore 212 of flange block at 203.

The centrifugal force imparted to the formation fluid flow by helical insert 205 provides additional energy for separating the solids from the formation fluids. Furthermore, since the fluid flow is inlet horizontally through inlet port 211 of flange block 202, the fluid downward velocity is reduced compared to conventional gravity separators. Advantageously, this reduced fluid velocity minimizes stirring in solid collection chamber 105 and increases the percentage of solids that remain in solid collection chamber rather than exiting through helical flow back separator 101.

Overall, the increased percentage of solids that are separated out of the formation fluids by flow back separator 101 realizes significant advantages. Among other things, the removal of solids from the fluid flow passing through the downstream piping and other processing equipment reduces erosion and similar damage. Additionally, the reduction in solids reduces the need to clean the downstream piping and processing equipment, which reduces the time necessary for equipment disassembly, reassembly, and testing.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims. It is therefore contemplated that the claims will cover any such modifications or embodiments that fall within the true scope of the invention.

What is claimed is:

1. A flow back separator comprising:
a housing having a housing bore therethrough for communicating with a solid collection chamber;
an inlet port for receiving formation fluid flow; and
a helical member disposed within the housing bore for directing formation fluid flow received through the inlet port along a helical path wherein solids within the formation fluid flow are forced towards a wall of the housing bore under centrifugal force.

2. The flow back separator of claim 1, wherein the housing bore has a longitudinal axis and the inlet port has axis disposed at an angle to the longitudinal axis of the housing bore.

3. The flow back separator of claim 2, wherein the inlet port is laterally offset from the longitudinal axis of the housing bore for initiating helical fluid flow along the helical member.

4. The flow back separator of claim 2, wherein the axis of the inlet port is disposed substantially perpendicular to the longitudinal axis of the housing bore.

5. The flow back separator of claim 1, wherein the helical member comprises a helical insert adapted for reception within the housing bore and having a helical projection of a selected number of turns disposed along a selected length of an outer surface of the helical insert and wherein the helical insert further includes a helical insert bore for communicating formation fluid flow exiting the flow back separator.

6. The flow back separator of claim 4, further comprising a wear sleeve adapted for reception with the housing bore and having a bore adapted to receive at least a portion of a length of the helical insert.

7. The flow back separator of claim 1, wherein the housing comprises:
a flange tube having a longitudinal bore therethrough; and
a flange block having a longitudinal bore aligned with the longitudinal bore of the flange tube and a side bore communicating with the longitudinal bore of the flange block and providing the inlet port.

8. A method of separating solids from a formation fluid comprising:
introducing a flow of formation fluid into a separator bore; and
applying centrifugal force to the flow of formation fluid within the separator bore to separate a percentage of solids within the formation fluid from the formation fluid.

9. The method of claim 8, wherein applying centrifugal force comprises directing the flow of formation fluid down a helical path within the separator bore such that solids within the formation fluid flow are forced towards a wall of the separator bore under centrifugal force.

10. The method of claim 8, wherein introducing a flow of formation fluid into the separator bore comprises introducing the flow of formation fluid into the separator bore through an inlet substantially perpendicular to a longitudinal axis of the separator bore.

11. The method of claim 10, wherein introducing a flow of formation fluid into the separator bore further comprises introducing the flow of formation fluid into the separator bore through the inlet laterally offset from the longitudinal axis of the separator bore.

12. The method of claim 9, wherein directing the flow of formation fluid down a helical path comprises directing the flow of formation fluid down a helical projection of a selected number of turns supported by insert disposed within the separator bore.

13. A helical flow back separator comprising:
a housing having a housing bore therethrough for communicating with a solids collection chamber;
a helical insert for insertion within the housing bore, the helical insert comprising a tube and a helical projection of a selected number of turns extending from the tube for defining a helical fluid path between an outer wall of the tube and a wall of the housing bore; and
an inlet port disposed substantially perpendicular to a longitudinal axis of the housing bore for introducing fluid flow in the helical fluid path.

14. The helical flow back separator of claim 13, wherein the inlet port is further laterally offset from the longitudinal axis of the housing bore.

15. The helical flow back separator of claim 13, further comprising a wear insert for disposition within the housing bore between the helical projection of the helical insert and the wall of the housing bore.

16. The helical flow back separator of claim 13, wherein the housing comprises:
a flange tube having a longitudinal bore therethrough; and
an inlet flange block having a longitudinal bore aligned with the longitudinal bore of the flange tube and a side bore communicating with the longitudinal bore of the flange block and providing the inlet port.

17. The helical flow back separator of claim 13, further comprising a variable length nozzle for attachment to a distal portion of the tube of the helical insert.
